(19) United States
(12) Patent Application Publication
(10) Pub. No.: US 2023/0153664 A1
(43) Pub. Date: May 18, 2023

(54) Stochastic Multi-Modal Recommendation and Information Retrieval System

(71) Applicant: Disney Enterprises, Inc., Burbank, CA (US)

(72) Inventor: Jayson Salkey, Edgewater, NJ (US)

(21) Appl. No.: 17/530,317

(22) Filed: Nov. 18, 2021

(51) Int. Cl. G06N 7/00

(52) U.S. Cl. CPC G06N 7/005

(57) ABSTRACT

A system includes a computing platform including processing hardware and a memory storing software code including a trained machine learning (ML) model. The processing hardware executes the software code to receive entity specific data over a network from a user device, identify mapping parameters of the entity specific data, and map, using the trained ML model and the mapping parameters, the entity specific data to a statistical distribution in a multi-dimensional representation space. The software code further compares, using the trained ML model, the mapped statistical distribution to each of one or more predetermined statistical distributions in the multi-dimensional representation space, predicts, to using the trained ML model and the comparison, a matching probability for each of the one or more predetermined statistical distributions relative to the mapped statistical distribution. generates a similarity set based on the prediction, and outputs the similarity set to the user device over the network.

### BACKGROUND

The volume of social media interactions and digital media content depicting sports, news, movies, television (TV) programming, print media, and music on digital platforms on the internet far exceeds the capacity of a user to discover and evaluate. Moreover, the sheer number of users of social media can make it difficult for any one user to identify other unfamiliar users with whom tastes and interests may be shared in common. Industrial-scale user and content modeling, as well as recommendation systems, are used to determine how users interact with items in order to model their interests and interaction behaviors.

Collaborative filtering has remained the dominant approach to making recommendations based on leveraging the modeled patterns between user interests and interactions with items. Deep learning models, optimized through gradient-based learning algorithms, have garnered interest at the industrial-scale for collaborative filtering tasks. However, a fundamental limitation of this approach is its inability to reconcile the popularity-bias inherent in the training data.

### BRIEF DESCRIPTION OF THE DRAWINGS

FIG. 1 shows an exemplary system for performing stochastic multi modal recommendation and information retrieval, according to one implementation;

FIG. 2 shows a diagram depicting mapping of entity specific data to statistical distributions in a multi-dimensional representation space, according to one implementation

FIG. 3A shows a flowchart outlining a method for performing stochastic multi-modal recommendation and information retrieval, according to one implementation;

FIG. 3B shows additional actions for extending the method outlined in FIG. 3A, according to one implementation; and

FIG. 4 shows a flow diagram of additional actions for performing entity mapping and characterization, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for performing stochastic multi-modal recommendation and information retrieval. It is noted that, as defined for the purposes of the present application, the term “entity” may refer to a person, place, event, or to any cognizably distinct set of data. Specific examples of entities include individual persons, entertainment events, real-world locations or attractions, such as theme park rides or other attractions, or to digital media content in the form of a movie or movie franchise, a television (TV) episode or series, a video game, digital music, a digital hook, content metadata and metadata categories applied to any of the foregoing examples of digital media content, as well as the social media history or media content consumption history and consumption habits of a user (user social media history or media content consumption history and consumption habits hereinafter referred to as an “activity profile”), to name a few.

With respect to the novel and inventive concepts disclosed herein, it is noted that in the rapidly proliferating social media and digital media content environment, search, recommendation, and presentation all play important roles in matching consumers or users (hereinafter “users”) with relevant other users, real-world events, and digital media content of which users may not be familiar with or even aware of. Collaborative filtering has traditionally been the dominant approach to making content recommendations based on modeled consumption patterns among users identified as having interests or tastes that are similar. More recently, some computational recommendation techniques have been adopted that include generating vector embeddings of items of content and utilizing the Euclidean distance between vectors, or another metric, as a proxy for similarity amongst the content items. These existing computational approaches suffer from several deficiencies, including:

1. Making assumptions on the geodesics of the embedding space using ad-hoc metrics such as, cosine similarity, Euclidean distance, or some specific norm. That is to say, such ad-hoc metrics and loose or arbitrary definitions of semantic similarity are typically relied upon to assign interpretable meaning to the embeddings in an embedding space.

2. Failing to provide quantitative uncertainty measures about the embedding of an item of content, metadata, or user.

3. Failing to reveal whether an item of content or other entity has multiple patterns of consumption or exhibits some aspects of polysemy (e.g. multiple meanings of metadata or multiple streaming contexts for digital media content).

4. Failing to describe how content items or other entities relate to one another in probabilistic terms.

5. Typically failing to take into account metadata associated with an entity and user activity.

The present application introduces a novel probabilistic approach, based on sequential user interactions, for learning representations and their corresponding uncertainty estimates item-to-item, metadata-to-item, activity profile-to-item, an activity profile-to-user recommendation, and user-to-user relationships, that addresses and overcomes the shortcomings identified above. In particular, the point-estimate vectors representation used in known models are expanded to more abstract multi-dimensional statistical distributions in which each entity can be represented by a mixture of Gaussians, for example, or any other suitable statistical distribution.

Metadata from one or more sources can be combined with user activity profiles in order to map genres, agents, subjects, content, and more in a multi-dimensional representation space. Each entity may be represented as a mixture model of several components trained using a pair-wise ranking loss. Pairs play be sampled according to their frequency in the content consumption corpus, the metadata corpus, or both. The representation of data describing individual entities as distributions allows for direct quantification of an uncertainty associated with the predicted similarity between various combinations of content, metadata, and user preferences. It is noted that there are multiple suitable approaches to quantifying uncertainty. Moreover, different statistical distributions for entities, e.g., Gaussian, Beta-binomial, or T-distributions, can result in different uncertainty values. Downstream applications, applications that receive the recommendations and information output by the systems and according o the methods disclosed herein, may include any or all of metadata-to-metadata similarity, content-to-metadata similarity, entailment of content and metadata, detecting polysemy (e.g., multiple meanings of metadata or multiple streaming contexts for content, as noted above), representing user as an ensemble of mixture models based on their activity profile, and stochastic set generation starting from a seed distribution corresponding to an entity, to name a few examples.

In some implementations, the systems and methods disclosed by the present application may be substantially or fully automated. It is noted that, as defined for the purposes of the the present application, the terms “automation,” “automated,” and “automating” refer to systems and processes that do not require the participation of a human system administrator. Although, in some implementations, a system administrator may review or modify the probabilistic predictions provided by the automated systems and according to the automated methods described herein, that human involvement is optional. Thus, in some implementations, the methods described in the present application may be performed under the control of hardware processing components of the disclosed automated systems.

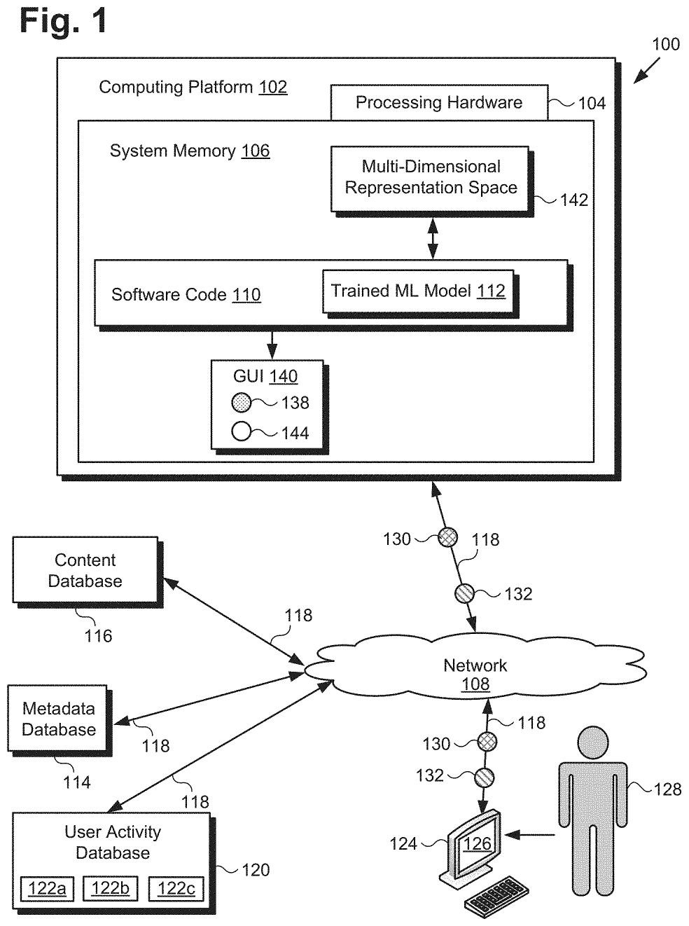

FIG. 1 shows an exemplary system for performing stochastic multi-modal recommendation and information retrieval, according to one implementation. As shown in FIG. 1, system 100 includes computing platform 102 having processing hardware 104 and system memory 106 implemented as a computer-readable non-transitory storage medium. According to the present exemplary implementation, system memory 106 stores software code 110 including trained machine learning (ML) model 112. Also shown in FIG. 1 are multi-dimensional representation space 142, graphical user interface (GUI) 140 provided by software code 110, similarity set 132, and entity description 138 and matching probability 144 displayed via GUI 140.

As defined in the present application, the expression “machine learning model” or “ML model” may refer to a mathematical model for making future predictions based on patterns learned from samples of data or “training data.” Various learning algorithms can be used to map correlations between input data and output data. These correlations form the mathematical model that can be used to make future predictions on new input data. Such a predictive model may include one or more logistic regression models, Bayesian models, or neural networks (NNs). Moreover, a “deep neural network,” in the context of deep learning, may refer to an NN that utilizes multiple hidden layers between input and output layers, which may allow for learning based on features not explicitly defined in raw data. As used in the present application, a feature identified as an NN refers to a deep neural network. In various implementations, NNs may be trained as classifiers and may be utilized to perform image processing, audio processing, or natural-language processing.

As further shown in FIG. 1, system 100 is implemented within a use environment including network 108, metadata database 114, content database 116, user activity database 120, and user device 124 including display 126. In addition, FIG. 1 shows user 128 of user device 124, entity specific data 130, activity profile 122a of user 128, and activity profiles 122b and 122c of other users (other users not shown in FIG. 1). Also shown in FIG. 1 are network communication links 118 of network 108 interactively connecting system 100 with metadata database 114, content database 116, user activity database 120, and user device 124.

It is noted that in some implementations, as depicted in FIG. 1, metadata database 114, content database 116, and user activity database 120 may be remote from but communicatively coupled to system 100 via network 108 and network communication links 118. However, in other implementations, one or more of metadata database 114, content database 116, and user activity database 120 may be assets of system 100, and may be stored locally in system memory 106.

Although the present application refers to software code 110 as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to processing hardware 104 of computing platform 102. Thus, a computer-readable non-transitory storage medium may correspond to various types of media, such as volatile media to and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

Moreover, although FIG. 1 depicts software code 110 and multi-dimensional representation space 142 as being co-located in system memory 106 that representation is merely provided as an aid to conceptual clarity. More generally, system 100 may include one or more computing platforms 102, such as computer servers for example, which may be co-located, or may form an interactively linked but distributed system, such as a cloud-based system, for instance. As a result, processing hardware 104 and system memory 106 may correspond to distributed processor and memory resources within system 100.

Processing hardware 104 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU). “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from system memory 106, while a GPU may be implemented to reduce the processing overhead of the CPU by performing computationally intensive graphics or other processing tasks. A TPU is an application-specific integrated circuit (ASIC) configured specifically for artificial intelligence (AI) processes such as machine learning.

In some implementations, computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of limited distribution or private network. In addition, or alternatively, in some implementations, system 100 may be implemented virtually, such as in a data center. For example, in some implementations, system 100 may be implemented in software, or as virtual machines.

Although user device 124 is shown as a desktop computer in FIG. 1, that representation is also provided merely as an example. More generally, user device 124 may be any suitable mobile or stationary computing device or system that implements data processing capabilities sufficient o enable use of GUI 140, support connections to network 108, and implement the functionality ascribed to user device 124 herein. For example, in other implementations, user device 124 may take the form of a laptop computer, tablet computer, smart TV, game platform, smartphone, or smart wearable device, such as a smartwatch, for example.

Display 126 of user device 124 may take the form of a liquid crystal display (LCD), a light-emitting diode (LED) display, an organic light-emitting diode (OLED) display, a quantum dot (QD) display, or any other suitable display screen that performs a physical transformation of signals to light. It is noted that, in some implementations, display 126 may be integrated with user device 124, such as when user device 124 takes the form of a laptop or tablet computer for example. However, in other implementations, for example where user device 124 takes the form of a computer tower in combination with a desktop monitor, display 126 may be communicatively coupled to, but not physically integrated with user device 124.

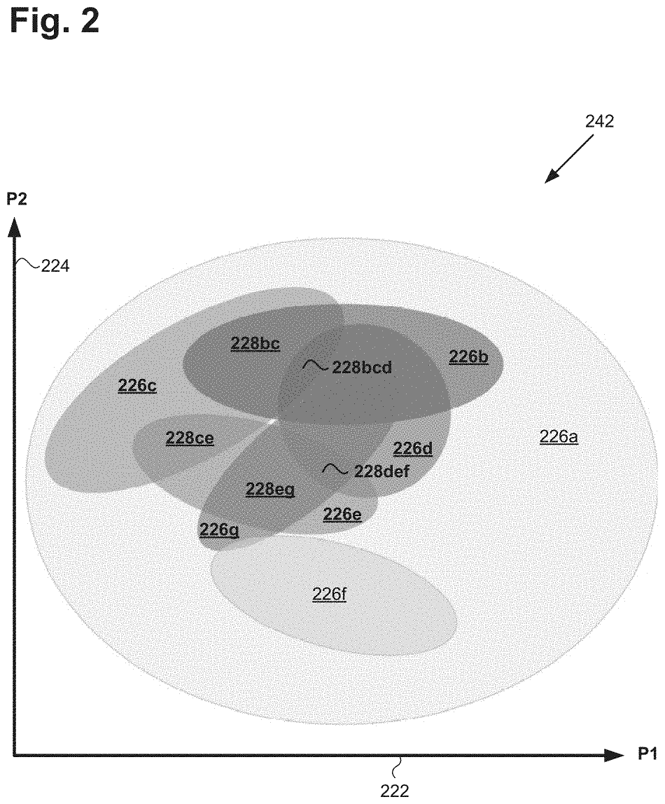

FIG. 2 shows a diagram depicting mapping of entity specific data to statistical distributions in multi-dimensional representation space 242, according to one implementation. It is noted that FIG. 2 shows a portion or subspace of multi-dimensional representation space 242 spanned by basis vectors 222 and 224 corresponding respectively to mapping parameters P1 and P2. However, it is emphasized that, in various use cases, multi-dimensional representation space 242 may include many more than two dimensions corresponding to two mapping parameters. For example, in some implementations, multi-dimensional representation space 242 may include hundreds or thousands of dimensions corresponding to hundreds or thousands of mapping parameters.

It is further noted that multi-dimensional representation space 242 corresponds in general to multi-dimensional representation space 142, in FIG. 1. Consequently, multi-dimensional representation space 142 may share any of the characteristics attributed to multi-dimensional representation space 242 by the present disclosure, and vice versa.

Referring to FIGS. 1 and 2 in combination, each instance of entity specific data 130 may be mapped to one or more statistical distributions in multi-dimensional representation space 242, i.e., one or more of statistical distributions 226a, 226b, 226c, 226d, 226e, 226f, and 226g thereinafter “statistical distributions 226a-226g”). That is to say, a first instance of entity specific data 130 may be mapped to statistical distribution 226a, a second instance of t entity specific data 130 may be mapped to statistical distribution 226b, a third instance of entity specific data 130 may be mapped to statistical distribution 26c, and so forth. In addition, FIG. 2 shows regions of intersection among two or more statistical distributions. For example, region 228bc shows the intersection of statistical distribution 226b with statistical distribution 226c, region 228eg shows the intersection of statistical distribution 226e with statistical distribution 226g, region 228bcd shows the portion of statistical distribution 226b that intersects both of statistical distributions and 226d, and so forth.

It is noted that, in various implementations, statistical distributions 226a-226g may each correspond to the same or different types of entities. For instance, statistical distribution 226a may correspond to a metadata category such as genre for example, while one or more other of statistical distributions 226a-226g may correspond to an item of content, and one or more others of statistical distributions 226a-226g may correspond to a user activity profile, such as one or more of activity profiles 122a, 122b, or 122c, in FIG. 1.

With respect to activity profiles 122a, 122b, and 122c, it is noted that, as defined for the purposes of the present application, the feature “activity profile” refers to a consumption history of a specific user, as well as, in some use cases, consumption habits of that user. For example, referring to activity profile 122a of user 128, activity profile 122a may include a history of content items consumed by user 128 or activities engaged in by user 128 as well as ratings feedback of that content or those activities provided to system 100 by user 128. In addition, in some implementations, activity profile 122a may identify the tunes of day and days of the week during which user 128 consumes content or engages in activities, whether user 128 typically consumes content items from beginning-to-end, or incrementally, use of to subtitles or other captioning, to name a few examples of consumption habits of user 128 that may be included in activity profile 122a.

It is further noted that, in some implementations, activity profile 122a may be exclusive of personally identifiable information (PII) of user 128. Thus, in those implementations, although activity profile 122a may serve to distinguish anonymous user 128 from other anonymous users associated with respective activity profiles 122b and 122c, user activity database 120 does not retain information describing the age, gender, race, ethnicity, or any other PII of any user. However, in some implementations, such as social media applications, for example, a user of system 100 may be provided an opportunity to opt in to having PII stored for the purposes of generating recommendations for connecting with other users based on predicted commonalities.

It is also noted that although the methods and systems disclosed by the present application are described by reference to a spec use case in which content recommendation are generated for a user, such as user 128, the present concepts may be readily applied to recommendations for a wide variety of assets. Examples of other assets hat maybe recommended to user 128 include other social media users, collectable items, entertainment events, and real-world attractions, such as theme park attractions, to name a few examples.

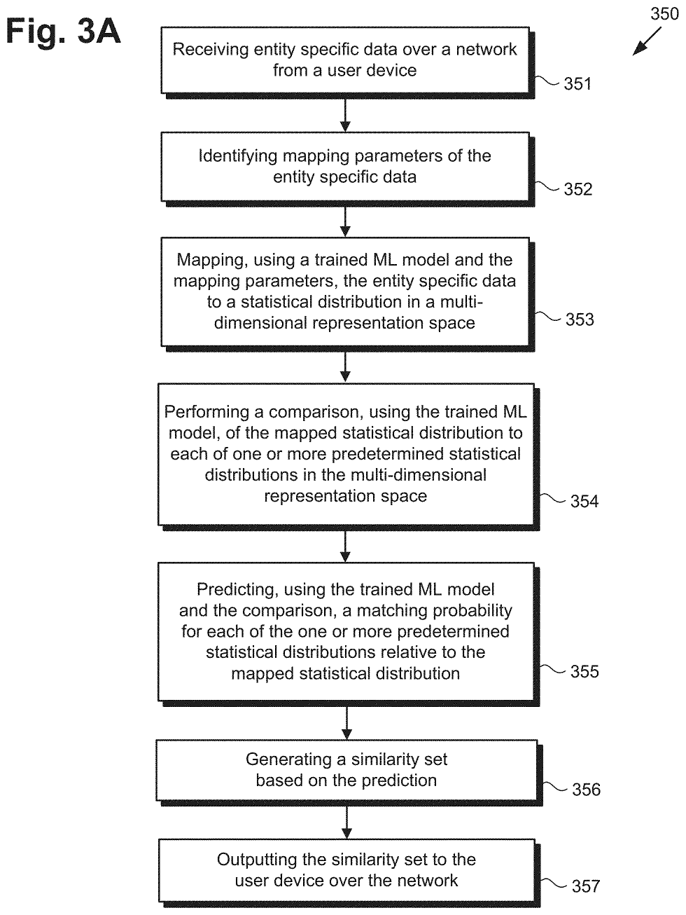

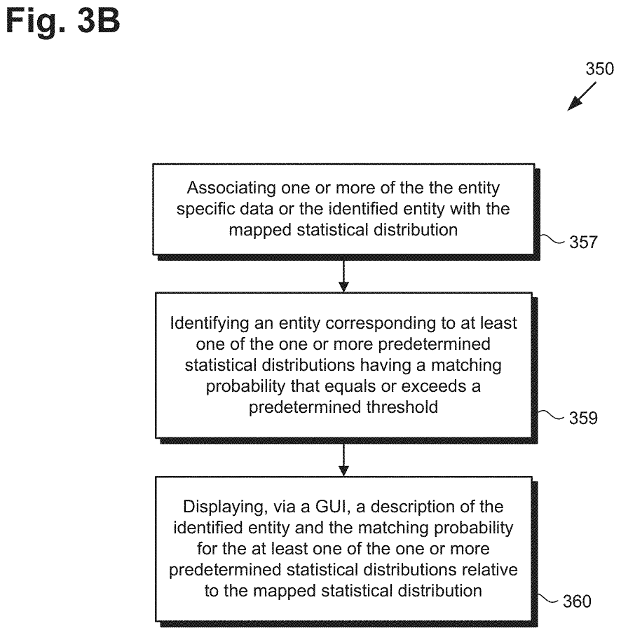

The functionality of software code 110, in FIG. 1, will be further described by reference to FIGS. 3A and 3B. FIG. 3A shows flowchart 350 presenting an exemplary method for performing stochastic multi-modal recommendation and information retrieval, according to one implementation, while FIG. 3B shows additional actions for extending the method outlined in FIG. 3A. With respect to the method outlined by FIGS. 3A and 3B, it is noted that certain details and features have been left out of flowchart 350 in order not to obscure the discussion of the inventive aspects disclosed in the present application.

Referring to FIG. 3A in combination with FIG. 1, flowchart 350 begins with receiving entity specific data 130 (action 351). As shown by FIG. 1, in one implementation, entity specific data 130 may be received from user device 124 by system 100 via network 108 and network communication links 118. In those implementations, entity specific data 130 may be received by software code 110, executed by processing hardware 104 of computing platform 102.

Entity specific data 130 may identify one or more of content or another type of entity, and metadata describing the content or entity. In addition, or alternatively, entity specific data may simply include metadata or a metadata category applicable to multiple content items. In addition, or as yet another alternative, in some use cases, entity specific data may include an activity profile of a user. As noted above, in implementations in which entity specific data 130 identifies content, that content may be digital media content in the form of a movie or movie franchise, a TV episode or series, a video game, digital music, or a digital look, for example. In some implementations in which entity specific data 130 includes an activity profile of a user, such as activity profile 122a of user 128, entity specific data 130 may omit any PII of the user. Moreover, in implementations in which entity specific data 130 identifies an entity other than digital media content, that entity may include another user, a collectable item, an entertainment event, or a real-world attraction, such as the me park attraction, for example.

Continuing to refer to FIGS. 1 and 3A in combination, flowchart 350 further includes identifying mapping parameters of entity specific data 130 (action 352). The to mapping parameters, such as mapping parameters P1 and P2 in FIG. 2, may vary from entity to entity. For example, where entity specific data 130 identifies a particular item of content, the mapping parameters may include the content type of that content item, i.e., a movie, TV programming content, video game, music, digital book, and so forth, as well as one or more of its digital file size, runtime or other time duration, genre, author, actors, and characters to name a few examples.

Where entity specific data 130 identifies metadata, mapping parameters may include content types, movies, TV programming content, video games, music, digital books, and so forth, as well as one or more of digital file sizes, runtimes or other time durations, genres, authors, actors, and characters to name a few examples. Where entity specific data 130 includes an activity profile of a user, such mapping parameters may include content items consumed or activities engaged in by the user, a sequence or sequences in which such content was consumed or the activities performed, as well as the consumption habits of the user, as described above. Identification of the mapping of entity specific data 130 may be performed in action 352 by software code 110, executed by processing hardware 104 of computing platform 102.

Referring to FIGS. 1, 2, and 3A in combination, flowchart 350 further includes mapping, using trained ML model 112 and the mapping parameters identified in action 352, entity specific data 130 to a statistical distribution in multi-dimensional representation space 142/242 (action 353). It is noted that, in some use cases, a single instance of entity specific data 130 may be mapped to multiple distinct statistical distributions. For example, where entity specific data 130 includes an activity profile of a user and further identifies an item of content, entity specific data 130 may be mapped to a first statistical distribution corresponding to the activity profile, as well as to a second statistical distribution corresponding to the item of content. Moreover, where entity specific data 130 further includes content metadata, entity specific data 130 may be mapped to yet a third statistical distribution corresponding to the content metadata. Mapping of entity specific data 130 to one or more statistical distributions may be performed by software code 110, executed by processing hardware 104 of computing platform. 102, using trained ML model 112 as noted above.

Flowchart 350 further includes performing a comparison, using trained ML model 112, of the mapped statistical distribution to each of one or more predetermined statistical distributions in multi-dimensional representation space 142/242 (action 354). By way of example, and referring to FIG. 2, let statistical distribution 226g be the statistical distribution that is mapped in action 353, and let statistical distributions 226a, 226b, 226c, 226d, 226e, and 226f (hereinafter “statistical distributions 226a-226f”) be the predetermined statistical distributions. Predetermined statistical distributions 226a-226f may each correspond to the same or different entities, and may correspond to the same or different entity to which mapped statistical distribution 226g corresponds. For instance, predetermined statistical distribution 226a may correspond to content metadata, such as a genre of content for example, while one or more other of predetermined statistical distributions 226a-226f may correspond to an item of content, and one or more others of statistical distributions 226a-226f may correspond to an activity profile of a user, such as activity profiles 122a, 122b, or 122c, in FIG. 1. Analogously, mapped statistical distribution 226g may correspond to an item of content, content metadata, or an activity profile of a user. Thus, in use cases in which mapped statistical distribution 226g corresponds to an entity in the form of activity profile 122a of user 128, one or more of predetermined statistical distributions 226a-226f may correspond to one or more of activity profiles 122b and 122c of other users.

The comparison of mapped statistical distribution 226g to one or more of predetermined statistical distributions 226a-226f in multi-dimensional representation space 142/242 may be performed using one or more of a variety of different comparative criteria. One example of such a criterion may include the extent to which mapped statistical distribution 226g intersects one or more of predetermined statistical distributions 226a-226f, e.g., the multi-dimensional intersection volume of mapped statistical distribution 226g with any of predetermined statistical distributions 226a-226f. Other examples of comparative criteria may include the respective mean values of mapped statistical distribution 226g and predetermined statistical distributions 226a-226f, the respective variance values of mapped statistical distribution 226g and predetermined statistical distributions 226a-226f, or both. The comparison of mapped statistical distribution 226g to one or more of predetermined statistical distributions 226a-226f in multi-dimensional representation space 142/242 may be performed by software code 110, executed by processing hardware 104 of computing platform 102, using trained ML, model 112 as noted above.

Flowchart 350 further includes predicting, using trained ML model 112 and the comparison performed in action 354, matching probability 144 for each of the one or more predetermined statistical distributions relative to the mapped statistical distribution (action 355). Matching probability 144 may be expressed as a normalized value in a range from zero (0.0) to one (1.0), for example, or as a percentage in a range from zero percent (0%) to (100%). One significant advantage of predicting r latching probability 144 rather than quantifying semantic similarity through computations involving high-dimensional vector to representations of content, as is done in existing approaches to assessing similarity, is that quantifying similarity through probabilistic calculations involving distributional representations of content, as disclosed by the present application, allows for assessment of similarity in terms of probability, as opposed to some vague measure such as Euclidian distance or cosine similarity. Expressing similarity in terms of probability not only provides a quantitative estimate of similarity, but can also provide a quantitative estimate of certainty.

Matching probability 144 for any one of the predetermined statistical distributions relative to the mapped statistical distribution may be predicted based on the ratio of the intersection volume of the statistical distribution mapped in action 353 with that predetermined statistical distribution to the total volume of the mapped statistical distribution, for example. Alternatively, or in addition, matching probability 144 may be based on one or more of the relative mean values or variance values of the mapped statistical distribution and the predetermined statistical distribution to which it is compared in action 354. The prediction of matching probability 144 in action 355 may be performed by software code 110, executed by processing hardware 104 of computing platform 102, using trained ML model 112. It is noted that although flowchart 350 shows action 354 as preceding action 355, that representation is merely exemplary. In other implementations, actions 354 and 355 may be performed in parallel, i.e., substantially concurrently.

Flowchart 350 further includes generating similarity set 132 based on the prediction performed in action 355 (action 356). Similarity set 132 may include any of the one or more predetermined statistical distributions having matching probability 144 that equals or exceeds a predetermined threshold. The generation of similarity set 132 in action 356 may performed by software code 110, executed by processing hardware 104 of computing to platform 102.

Flowchart 350 further includes outputting similarity set 132 to user system 124 (action 357). As shown by FIG. 1, in one implementation, similarity set 132 may be output to user device 124 by system 100 via network 108 and network communication links 118. In those implementations, similarity set 132 may be output to user device 124 by software code 110, executed by processing hardware 104 of computing platform 102.

In some implementations, the method outlined by flowchart 350 may conclude with action 357 described above by reference to FIG. 3A. However, as shown by FIG. 3B, in some implementations, flowchart 350 may further include associating at least one of entity specific data 130 received in action 351, or an entity corresponding to that entity specific data, with the statistical distribution mapped in action 353 (action 358). That is to say, entity specific data 130 received in action 351, or an entity corresponding to that entity specific data, may be cross-referenced with, or otherwise identified with, its corresponding statistical distribution in multi-dimensional representation space 142/242. Action 358 may be performed by software code 110, executed by processing hardware 104 of computing platform 102.

As further shown by FIG. 3B, in some implementations, the method outlined by flowchart 350 may also include identifying an entity corresponding to at least one of the predetermined statistical distributions having a matching probability that equals or exceeds a predetermined threshold (action 359) and displaying ,via GUI 140, entity description 138 of that identified entity and its corresponding matching probability 144 (action 360). Actions 358 and 359 may be performed by software code 110, executed by processing hardware 104 of computing platform 102. Although flowchart 350 shows action 359 as preceding action 360, that representation is merely exemplary. In other implementations, actions 359 and 360 may be performed in parallel, i.e., substantially concurrently.

The representation of entities as statistical distributions, as described above, advantageously enables a variety of different personalization and recommendation use cases, including item-to-item metadata-to-item, activity profile-to-item, activity profile-to-user, and user-to-user implementations. With respect to item-to-item use cases, existing techniques typically employ some form of similarity metric which measures similarity monotonically (e.g., cosine similarity or Euclidean distance). Unfortunately, the respective distributions of those employed metrics are often not accounted for and items that might appear quite unrelated with respect to those metrics may in fact be strongly related, when holistically considering all other items. In contrast, the present solution, by representing entities as distributions, extends the idea of using a similarity metric for relatedness by also explicitly considering the uncertainty or variance of how pairs of entities might be related to one another.

Regarding metadata-to-item use cases, metadata associated with an item is also represented as a statistical distribution. As is also true of item-to-item use cases, probabilistic statements can be made about the relationship of metadata to various items. As an example, statistical distributions for movie “A,” movie “B,” and the genre “action-adventure” can be compared to predict how much more, or less “action adventure like” movie “A” is than movie “B.”

For the activity profile-to-item, activity profile-to-user, and user-to-user implementations, the present novel and inventive approach to using statistical distribution as representations of entities allows end users to derive abstract grouping of items and metadata for further use cases. For example, distributions for activity profiles can be produced by algorithmically aggregating the distributions of all previous activities as they relate to digital media content, real-world events, or engagement with other users, thereby providing probabilistic predictions as to what content, events, or other users a particular user is likely to have a high or low affinity towards. By way of example, the probability that a consumer of movie franchise “C” is likely to enjoy movie franchise “D” can be quantified and used to inform downstream recommendation algorithms.

Another advantageous feature of multi-modal distributions as opposed to traditional uni-modal distributions is the side-effect of capturing polysemy or multiple meanings or modes of consumptions for particular items or metadata. One example might be that a particular character has a distribution with two modes, such as in both cartoons and movies for instance. If these two modes are analyzed separately, it may be found that one component of the distribution is related to decades old cartoons and another mode is related to more modern feature films. This detection of multiple modes of consumption or item-to-item affinity can further inform downstream analysis on profiles and recommendation algorithms.

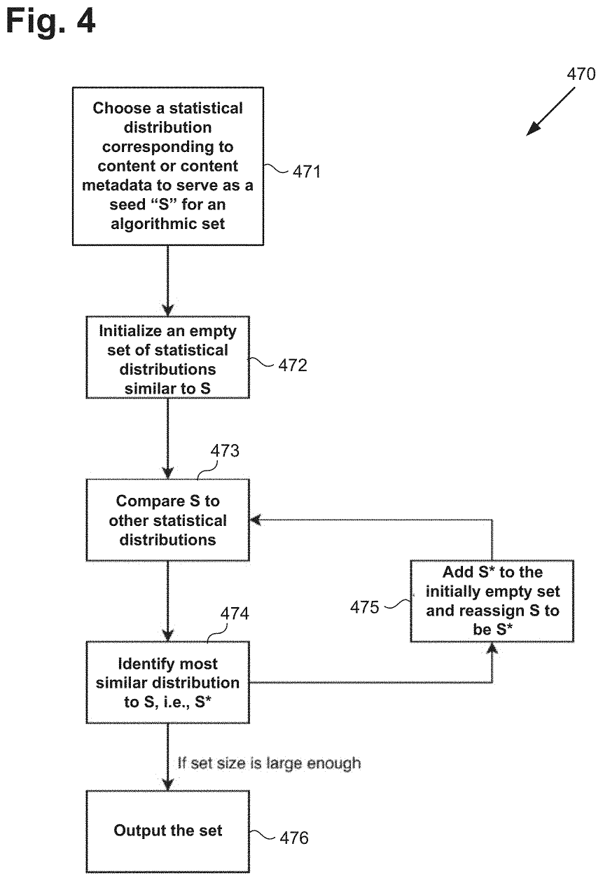

FIG. 4 shows flow diagram 470 of additional actions for performing entity mapping and characterization, according to one implementation. With respect to flow diagram 470, it is noted that although FIG. 4 focuses on a use case in which the mapped and characterized entities are one or more of content and content metadata, that representation is merely provided in the interests of conceptual clarity. In other implementations, the approach outlined by flow diagram 470 can readily be adapted to other pairs of entities, such as any of the item-to-item, metadata-to-item, activity profile-to-item, activity profile-to-user, and user-to-user implementations described above.

As shown in FIG. 4, flow diagram 470 includes choosing an item of content, or content metadata, to serve as a seed statistical distribution “S” for generating an algorithmic set (action 471), initializing an empty set to be populated by statistical distributions similar to S (action 472), and comparing S to other statistical distributions in a multi-dimensional representation space corresponding to multi-dimensional representation space 142/242 in FIGS. 1 and 2 (action 473). By way of example, the entity identified in action 359 of flowchart 350 as having a matching probability that equals or exceeds a predetermined threshold may be chosen as a seed in action 471 and used in subsequent actions 472 and 473. Referring to FIG. 1 in combination with FIG. 4, actions 471, 472, and 473 may be performed by software code 110, executed by processing hardware 104 of computing platform 102.

Flow diagram 470 further includes identifying another statistical distribution, “S*” most similar to S (action 474), based for example on any of the criteria discussed above by reference to actions 354 and 355 of flowchart 350, as well as adding S* to the set initialized in action 472 and reassigning S to be S* (action 475), that is to say, adding S* to the initially empty set and substituting S* for S for the purposes of subsequent comparisons. Actions 473, 474, and 475 can be repeated until the set initialized in action 472 grows to a predetermined or otherwise desirable size, at which point, the process outlined by flow diagram 470 may conclude with outputting the set in action 476. In this way, a similarity set can be dynamically generated. Referring to FIG. 1 in combination with FIG. 4, actions 474, 475, and 476 may be performed by software code 110, executed by processing hardware 102 of computing platform 102.

Thus, in some implementations, processing hardware 104 of system 100 may be to further configured to execute software code 110 to, for the predetermined statistical distributions identified in action 359 of flowchart 350 for which the matching probability equals or exceeds the predetermined threshold, identify another predetermined statistical distribution having another matching probability equaling or exceeding the predetermined threshold relative to the predetermined statistical distribution identified in action 359. In addition, processing hardware 104 of system 100 may execute software code 110 to perform another comparison, using trained ML model 112, of the statistical distribution mapped in action 353 of flowchart 350 to that other predetermined statistical distribution and predict, using trained ML model 112 and the other comparison, another matching probability for the other predetermined statistical distribution relative to the mapped statistical distribution.

Referring to FIG. 2 for a more specific example of the actions outlined in the previous paragraph, where statistical distribution 226g is the statistical distribution mapped in action 353, and predetermined statistical distribution 226e is the predetermined statistical. distribution identified in action 359 for which matching probability 144 relative to mapped statistical distribution 226g equals or exceeds the predetermined threshold, processing hardware 104 may execute software code 110 to identify another predetermined statistical distribution, e.g., predetermined statistical distribution 226b, having another matching probability equaling or exceeding the predetermined threshold relative to predetermined statistical distribution 226e identified in action 359. In addition, processing hardware 104 of system 100 may execute software code 110 to perform another comparison, using trained ML model 112, of statistical distribution 226g mapped in action 353 to predetermined statistical distribution 226b, and to predict, using trained ML model 112 and that other comparison, another matching probability for predetermined statistical distribution 226b relative to mapped statistical distribution 226g.

With respect to the methods outlined by flowchart 350 and flow diagram 470, it is emphasized that, in some implementations, actions 351, 352, 353, 354, 355, 356, and 357 (hereinafter “actions 351-357”), or actions 351-357 and action 358, or actions 351-357 and actions 358 and 359, or actions 351-357 and actions 358, 359, and 360, or actions 471, 472, 473, 474, 475, and 476 (hereinafter “actions 471-476”), or actions 351-357 and actions 471-476, or actions 351-357 and actions 358 and 471-476, or actions 351-357 and actions 358, 359 and 471-476, or actions 351-357 and actions 358, 359, 360 and 471-476, may be performed in an automated process from which human involvement may be omitted.

Thus, the present application discloses systems and methods for performing stochastic multi-modal recommendation and information retrieval. The present solution advantageously improvise upon the state-of-the-art in several ways, including providing uncertainty measures associated with the embedding of an entity in the form of an item of content, content metadata or metadata category, or an activity profile of a user, revealing whether an entity has multiple patterns of consumption or exhibits some aspects of polysemy, and describing how entities relate to one another in probabilistic terms while taking into account metadata, user activity, or both.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including a processing hardware and a system memory;
a software code including a trained machine learning (ML) model stored in the system memory;
the processing hardware configured to execute the software code to:
receive entity specific data over a network from a user device;
identify a plurality of mapping parameters of the entity specific data;
map, using the trained ML model and the plurality of mapping parameters, the entity specific data to a statistical distribution in a multi-dimensional representation space;
perform a comparison, using the trained ML model, of the mapped statistical distribution to each of one or more predetermined statistical distributions in the multi-dimensional representation space;
predict, using the trained ML model and the comparison, a matching probability for each of the one or more predetermined statistical distributions relative to the mapped statistical distribution;
generate a similarity set based on the prediction; and
output the similarity set to the user device over the network.

2. The system of claim 1, wherein the software code is configured to provide a graphical user interface (GUI), and wherein the processing hardware is further configured to execute the software code to:
identify an entity corresponding to at least one of the one or more predetermined statistical distributions having a matching probability that equals or exceeds a predetermined threshold; and
display, via the GUI, a description of the identified entity and the matching probability for the at least one of the one or more predetermined statistical distributions relative to the mapped statistical distribution.

3. The system of claim 1, wherein the processing hardware is further configured to execute the software code to:
associate at least one of the entity specific data or an entity corresponding to the entity specific data with the mapped statistical distribution.

4. The system of claim 1, wherein the comparison is performed using at least one of a mean value and a variance value of the mapped statistical distribution.

5. The system of claim 1, wherein the entity specific data identifies at east one of content or content metadata.

6. The system of claim 5, wherein at least one of the one or more predetermined statistical distributions corresponds to at least one of another content another content metadata.

7. The system of claim 1, wherein the entity specific data comprises an activity profile of a user.

8. The system of claim 7, wherein at least one of the one or more predetermined statistical distributions corresponds to an activity profile of another user.

9. The system of claim 1, wherein the similarity set comprises one or more of: an item-to-item recommendation, a metadata-to-item recommendation, an activity profile-to-item recommendation, an activity profile-to-user recommendation, or a user-to-user recommendation.

10. The system of claim 1, wherein the processing hardware is further configured to execute the software code to:
for one of the one or more predetermined statistical distributions for which the matching probability equals or exceeds a predetermined threshold:
identify another predetermined statistical distribution having another matching probability equaling or exceeding the predetermined threshold relative to the one of the one or more predetermined statistical distributions;
perform another comparison, using the trained ML model, of the mapped statistical distribution to the another predetermined statistical distribution; and
predict, using the trained ML model and the another comparison, another matching probability for the another predetermined statistical distribution relative to the mapped statistical distribution.

11. A method for use by a system including a computing platform having a processing hardware and a system memory storing a software code including a trained machine learning (ML) model, the method comprising:
receiving, by the software code executed by the processing hardware, entity specific data over a network from a user device;
identifying, by the software code executed by the processing hardware, a plurality of mapping parameters of the entity specific data;
mapping, by the software code executed by the processing hardware and using the trained ML model and the plurality of mapping parameters, the entity specific data to a statistical distribution in a multi-dimensional representation space;
performing a comparison, by the software code executed by the processing hardware using the trained ML model, of the mapped statistical distribution to each of one or more predetermined statistical distributions in the multi-dimensional representation space;
predicting, by the software code executed by the processing hardware and using the trained ML model and the comparison, a matching probability for each of the one or more predetermined statistical distributions relative to the mapped statistical distribution;
generating, by the software code executed by the processing hardware, a similarity set based on the prediction; and
outputting, by the software code executed by the processing hardware, the similarity set to the user device over the network.

12. The method of claim 11, wherein the software code is configured to provide a graphical user interface (GUI), the method further comprising:
identifying, by the software code executed by the processing hardware, an entity corresponding to at least one of the one or more predetermined statistical distributions having a matching probability that equals or exceeds a predetermined threshold; and
displaying, by the software code executed by the processing hardware and via the GUI, the a description of the identified entity and the matching probability for the at least one of the one or more predetermined statistical distributions relative to the mapped statistical distribution.

13. The method of claim 11, further comprising:
associating, by the software code executed by the processing hardware, at least one of the entity specific data or an entity corresponding to the entity specific data with the mapped statistical distribution.

14. The method of claim 11, wherein the comparison is performed using at least one of a mean value and a variance value of the mapped statistical distribution.

15. The method of claim 11 wherein the entity specific data identifies at east one of content and content metadata.

16. The method of claim 15, wherein at least one of the one or more predetermined statistical distributions corresponds to at least one of another content or another content metadata.

17. The method of claim 11, wherein the entity specific data comprises an activity profile of a user.

18. The method of claim 17, wherein at least one of the one or more predetermined statistical distributions corresponds to an activity profile of another user.

19. The method of claim 11, wherein the similarity set comprises one or more of: an item-to-item recommendation, a metadata-to-item recommendation, an activity profile-to-item recommendation, an activity profile-to-user recommendation, or a user-to-user recommendation.

20. The method of claim 11, further comprising:
for one of the one or more predetermined statistical distributions for which the matching probability equals or exceeds a predetermined threshold:
identifying, the software code executed by the processing hardware, another predetermined statistical distribution having another matching probability equaling or exceeding the predetermined threshold relative to the one of the one or more predetermined statistical distributions;
performing another comparison, by the software code executed by the processing hardware and using the trained ML model, of the mapped statistical distribution to the another predetermined statistical distribution; and
predicting, by the software code executed by the processing hardware and using the trained ML model and the another comparison, another matching probability for the another predetermined statistical distribution relative to the mapped statistical distribution.
